(19) United States
(12) Patent Application Publication
(10) Pub. No.: US 2026/0182649 A1
(43) Pub. Date: Jul. 2, 2026

(54) AEROSOL-GENERATING DEVICE

(71) Applicant: KT&G CORPORATION, Daejeon (KR)

(72) Inventors: Hee Jeong HONG, Seoul (KR); Hyunho AHN, Seoul (KR); Minseok JEONG, Seoul (KR); HyungJin JUNG, Seoul (KR)

(73) Assignee: KT&G CORPORATION, Daejeon (KR)

(21) Appl. No.: 19/348,702

(22) Filed: Oct. 2, 2025

(30) Foreign Application Priority Data
Dec. 31, 2024 (KR) 10-2024-0201622

(51) Int. Cl. A24F 40/46; H05B 6/70; H05B 6/80

(52) U.S. Cl. CPC A24F 40/46; H05B 6/701; H05B 6/80

(57) ABSTRACT

An aerosol-generating device includes a generator configured to generate a microwave, a resonator configured to resonate the microwave and including a conductor that defines a cavity configured to accommodate an aerosol-generating article, and an opening in which the aerosol-generating article is inserted, wherein the conductor includes a first area that is adjacent to the opening and includes an embossed surface, and a second area that is different from the first area.

### CROSS-REFERENCE TO RELATED APPLICATION

This application claims the benefit of Korean Patent Application No. 10-2024-0201622 filed on Dec. 31, 2024, in the Korean Intellectual Property Office, the entire disclosure of which is incorporated herein by reference for all purposes.

### BACKGROUND

### 1. Field of the Invention

The disclosure generally relates to an aerosol-generating device, and more particularly, a dielectric heating aerosol-generating device.

### 2. Description of the Related Art

Recently, the demand for aerosol-generating devices has gradually increased. In addition, with the growing demand for aerosol-generating devices, functions related to aerosol-generating devices have been continuously developed. Specifically, functions related to the type and characteristics of the aerosol-generating device have been continuously developed. The demand for a system for generating an aerosol by heating an aerosol-generating article using an aerosol-generating device has increased rather than a method of generating an aerosol by burning an aerosol-generating article. Electromagnetic wave heating technology is a technology that heats an object by using the principle of dielectric heating. An aerosol-generating article may be rapidly heated using the electromagnetic wave heating technology. The above description is information the inventor(s) acquired during the course of conceiving the present disclosure, or already possessed at the time, and is not necessarily art publicly not known before the present application was filed.

### SUMMARY

An aspect of the disclosure may provide an aerosol-generating device in which microwaves are scattered.

An aerosol-generating device includes a generator configured to generate a microwave, a resonator configured to resonate the microwave and including a conductor that defines a cavity configured to accommodate an aerosol-generating article, and an opening in which the aerosol-generating article is inserted, wherein the conductor includes a first area that is adjacent to the opening and includes an embossed surface, and a second area that is different from the first area.

The embossed surface includes a circular pattern.

The embossed surface includes a polygonal pattern.

The embossed surface includes a ribbed pattern.

The the conductor includes a coating disposed on the embossed surface and configured to scatter a microwave.

The second area includes an embossed surface.

A density of a pattern of the embossed surface of the first area is higher than a density of a pattern of the embossed surface of the second area.

The embossed surface of the second area includes a circular pattern.

An aerosol-generating device includes a generator configured to generate a microwave, a resonator configured to resonate the microwave and including a conductor that defines a cavity configured to accommodate an aerosol-generating article, and an opening in which the aerosol-generating article is inserted, wherein the conductor includes a first plate surrounding an area of the aerosol-generating article and including a first area adjacent to the opening and including an embossed surface and a second area that is different from the first area, and a second plate surrounding another area of the aerosol-generating article and spaced apart from the first plate in a circumferential direction of the aerosol-generating article.

The embossed surface includes a circular pattern.

The embossed surface includes a polygonal pattern.

The embossed surface includes a ribbed pattern.

The second area includes an embossed surface.

A density of a pattern of the embossed surface of the first area is higher than a density of a pattern of the embossed surface of the second area.

The embossed surface of the second area includes a circular pattern.

According to an embodiment, microwaves may be scattered. The effects of an aerosol-generating device are not limited to the above-mentioned effects, and other unmentioned effects can be clearly understood from the above description by those having ordinary skill in the technical field to which the present disclosure pertains.

### BRIEF DESCRIPTION OF THE DRAWINGS

The foregoing and other aspects, features, and advantages of embodiments in the disclosure will be apparent from the following detailed description with reference to the accompanying drawings.

FIG. 1 is a block diagram of an aerosol-generating device according to an embodiment.

FIG. 2 is a perspective view of an aerosol-generating device.

FIG. 3 is a perspective view of a heater assembly.

FIG. 4 is a plan view of an embossed surface.

FIG. 5 is a plan view of an embossed surface.

FIG. 6 is a plan view of an embossed surface.

FIG. 7 is a plan view of an embossed surface.

### DETAILED DESCRIPTION

Hereinafter, the embodiments disclosed in the present specification will be described in detail with reference to the accompanying drawings. The same or similar elements are denoted by the same reference numerals even though they are depicted in different drawings, and redundant descriptions thereof will be omitted. With regard to the description of the drawings, similar reference numerals may be used to refer to similar or related elements.

In the following description, with respect to constituent elements used in the following description, the suffixes “module” and “unit” are used only in consideration of facilitation of description, and do not have mutually distinguished meanings or functions. As used herein, the suffix “module” or “unit” may include a unit implemented in hardware, software, or firmware, and may be used interchangeably with other terms, for example, “logic,” “logic block,” “part,” or “circuitry.” A “module” or a “unit” may be a single integral component, or a minimum unit or part thereof, adapted to perform one or more functions. For example, the “module” or the “unit” may be implemented in the form of an application-specific integrated circuit (ASIC).

In addition, in the following description of the embodiments disclosed in the present specification, a detailed description of known functions and configurations incorporated herein will be omitted when the same may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents, and substitutions within the scope and spirit of the present disclosure.

It will be understood that although the terms “first”, “second”, etc., may be used herein to describe various components, these components should not be limited by these terms. These terms are only used to distinguish one component from another component.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, the singular form is intended to include the plural forms as well, unless the context clearly indicates otherwise.

Embodiments as set forth herein may be implemented as software including one or more instructions that are stored in a storage medium (e.g., a memory) that is readable by a machine (e.g., the aerosol-generating device 1). For example, a processor (e.g., a processor 170) of the machine (e.g., the aerosol-generating device 1) may invoke at least one of the one or more instructions stored in the storage medium, and may execute the same. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

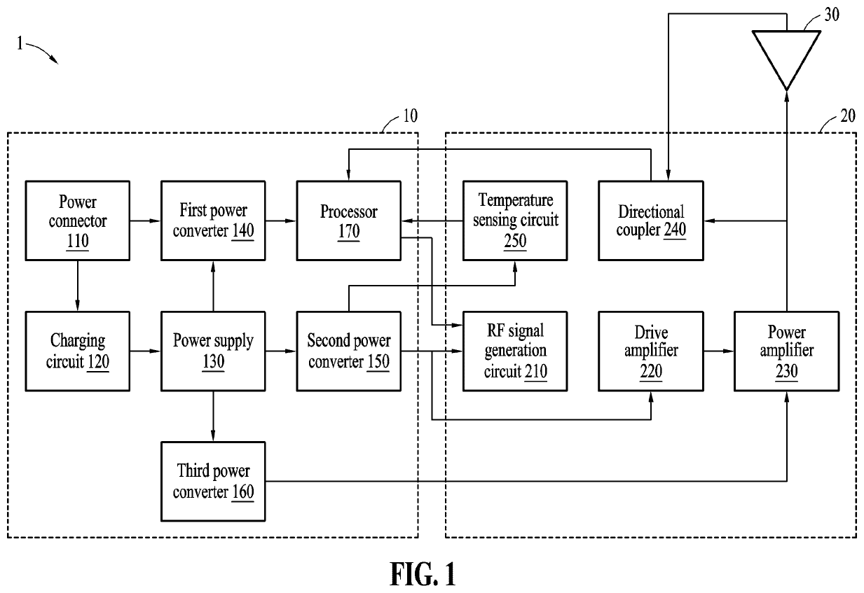

FIG. 1 is a block diagram of an aerosol-generating device 1 according to an embodiment.

According to one embodiment, the aerosol-generating device 1 may include a controller 10, a source unit 20, and a radiating unit 30. The controller 10 may refer to a circuit for controlling the basic operation of the aerosol-generating device 1. The source unit 20 may refer to a circuit for generating a radio frequency (RF) signal under the control of the controller 10. The radiating unit 30 may be a device for radiating the RF signal generated by the source unit 20 into a space into which an aerosol-generating article is inserted (hereinafter, referred to as an insertion space) in the form of an electromagnetic wave. The radiated electromagnetic wave (e.g., the RF signal) may cause electric charges or ions of a dielectric (e.g., glycerin) included in the aerosol-generating article to vibrate or rotate, and the aerosol-generating article may be heated as the dielectric is heated by the frictional heat generated during the process in which the electric charges or ions vibrate or rotate. In other words, the aerosol-generating device 1 may be a device for generating an aerosol by heating the aerosol-generating article using a dielectric heating method.

In one embodiment, the controller 10 may include a power connector 110, a charging circuit 120, a power supply 130, a first power converter 140, a second power converter 150, a third power converter 160, and/or a processor 170. In addition, the source unit 20 may include an RF signal generation circuit 210, a drive amplifier 220, a power amplifier 230, a directional coupler 240, and/or a temperature sensing circuit 250. That is, it will be understood by those skilled in the art related to the present embodiment that some of the components shown in FIG. 1 may be omitted or new components may be further included depending on the design of the aerosol-generating device 1.

The power connector 110 may refer to a physical connection device that is electrically connected to an electronic device or system (e.g., an external power supply) outside the aerosol-generating device 1 and used to transmit and receive power. For example, the power connector 110 may receive power from the external power supply and transfer the received power to a component that needs to be charged (e.g., the power supply 130). The power connector 110 may also provide a path for data transmission. The aerosol-generating device 1 may transmit and receive data to and from an external electronic device or system (e.g., a smartphone, a computer, etc.) via the power connector 110. The power connector 110 may include a universal serial bus (USB) power connector, a direct current (DC) power connector, and the like. In an example, the power connector 110 may be a USB-C type connector for supplying a DC voltage of 9V at a current of 1 A, but is not necessarily limited thereto. The power connector 110 may include an interface for wirelessly transmitting and receiving power.

The charging circuit 120 may refer to a circuit for charging the power supply 130. The charging circuit 120 may charge the power supply 130 using the power received from the power connector 110. In an example, the charging circuit 120 may be implemented as a charger integrated circuit (IC), which is an IC that performs functions to effectively and safely charge the power supply 130. The charging circuit 120 may monitor the voltage, current, and/or temperature of the power supply 130 to monitor the charging state of the power supply 130 or optimize the charging process. For example, the charging circuit 120 may detect the state of the power supply 130, and provide appropriate charging voltage and current to prevent overcharging or overdischarging.

The power supply 130 may supply power for the operation of the aerosol-generating device 1. The power supply 130 may include one or more rechargeable batteries. The power supply 130 may supply power to the radiating unit 30, so that the radiating unit 30 may radiate an electromagnetic wave (e.g., an RF signal) into the insertion space to heat the aerosol-generating article. Here, the supply of power to the radiating unit 30 may have the same meaning as the supply of power to the source unit 20. In addition, the power supply 130 may supply power necessary for the operation of the processor 170, the RF signal generation circuit 210, the drive amplifier 220, the power amplifier 230, the temperature sensing circuit 250, and the like. In an example, the power supply 130 may be lithium polymer (LiPoly) batteries, but is not limited thereto. The power supply 130 may also be replaceable (removable) batteries (hereinafter, detachable batteries). The detachable batteries may be mounted in or removed from a battery receiving unit provided in the aerosol-generating device 1. The detachable batteries may be charged in a wired and/or wireless manner.

The aerosol-generating device 1 may include a power conversion circuit for converting the power supplied from the power supply 130 to a power (e.g., voltage and/or current) appropriate for other components. The power conversion circuit may include at least one of a buck converter, a buck-boost converter, a boost converter, a Zener diode, and a low-dropout (LDO)regulator. In addition, the power conversion circuit may further include, if necessary, a DC/alternating current (AC) converter (e.g., an inverter).

In an example, the aerosol-generating device 1 may include the first power converter 140, the second power converter 150, and the third power converter 160. The first power converter 140 may be an LDO regulator for supplying power (e.g., DC 3.3V) appropriate for the processor 170, the second power converter 150 may be a buck-boost converter for supplying power (e.g., DC 5V) appropriate for the temperature sensing circuit 250, the RF signal generation circuit 210, and the drive amplifier 220, and the third power converter 160 may be a boost converter for supplying power (e.g., DC 12V/25W) appropriate for the power amplifier 230.

However, the first power converter 140, the second power converter 150, and the third power converter 160 are not limited to the examples described above, and may include other types of power conversion circuits. In addition, although FIG. 1 illustrates the aerosol-generating device 1 including three power converters, the aerosol-generating device 1 may include more or fewer power converters. In an example, at least some of the first power converter 140, the second power converter 150, and the third power converter 160 may be integrated into a single power converter.

The processor 170 may control the overall operation of the aerosol-generating device 1. For example, the processor 170 may directly or indirectly control the charging and discharging of the power supply 130 using the charging circuit 120. In addition, the processor 170 may control the voltage and/or current output by the power conversion circuit by adjusting the frequency and/or duty ratio of current pulses input to at least one switching element of the power conversion circuit. The processor 170 may control the overall operation of the components described later, in addition to the components described above.

The processor 170 may be implemented as an array of multiple logic gates, or may be implemented as a combination of a general-purpose microcontroller unit (MCU) (or microprocessor) and a memory in which a program executable by the MCU is stored. In addition, it will be understood by those skilled in the art to which the present embodiment belongs that the processor 170 may also be implemented as another type of hardware.

The RF signal generation circuit 210 may generate an RF signal based on power received from the power supply 130 or the second power converter 150. The RF signal may refer to a signal having a frequency in the range of 300 megahertz (MHz) to 300 gigahertz (GHz). In an example, the RF signal may have a frequency in the range of 1 GHz to 100 GHz. In addition, the RF signal may have a frequency in the Industrial, Scientific and Medical (ISM) equipment band, such as a frequency of 915 MHz, 2.45 GHz, and/or 5.8 GHz.

The RF signal generation circuit 210 may include a voltage-controlled oscillator (VCO) that generates an RF signal having a different frequency according to an input voltage. The RF signal generation circuit 210 may receive a control signal (e.g., a DC signal) from the processor 170 and generate an RF signal having a frequency corresponding to the received control signal. The processor 170 may store control signals corresponding to desired frequencies in the form of a look-up table, or may calculate a control signal corresponding to a desired frequency in real time through at least one operation.

In an example, the aerosol-generating device 1 may further include a digital-to-analog converter (D/A converter) for converting a digital control signal output from the processor 170 to an analog control signal. The RF signal generation circuit 210 may receive the analog control signal and generate an RF signal having a frequency corresponding to the received analog control signal.

The drive amplifier 220 may amplify the RF signal generated by the RF signal generation circuit 210. For example, the drive amplifier 220 may amplify the signal level (e.g., the amplitude) of the RF signal, thereby providing an input signal appropriate for a subsequent component (e.g., the power amplifier 230). The drive amplifier 220 may minimize signal distortion by maintaining high linearity. However, the drive amplifier 220 is an amplifier focusing on increasing the signal level and thus may provide relatively low output power.

The power amplifier 230 may amplify the power of the RF signal received from the drive amplifier 220. The power amplifier 230 may be an amplifier focusing on providing sufficient power to a final output device (e.g., the radiating unit 30). For example, the power amplifier 230 may provide an RF signal with high power to the radiating unit 30 such that the radiating unit 30 may radiate an electromagnetic wave into the insertion space to heat the aerosol-generating article. The power amplifier 230 may perform the amplification operation using power received through the third power converter 160 that provides higher power and/or voltage than the second power converter 150.

The drive amplifier 220 and the power amplifier 230 may include transistors such as bipolar junction transistors (BJTs) and field-effect transistors (FETs), or vacuum tubes. In an example, the drive amplifier 220 and the power amplifier 230 may be gallium nitride (GaN) transistors for high-efficient, high-speed, and high-voltage processing, but are not necessarily limited thereto. The drive amplifier 220 and the power amplifier 230 may also include operational amplifiers.

Meanwhile, although FIG. 1 illustrates the drive amplifier 220 and the power amplifier 230 as individual amplifiers, the drive amplifier 220 and the power amplifier 230 may be integrated into a single amplifier. In addition, the drive amplifier 220 and/or the power amplifier 230 may also be configured as a series connection of a plurality of amplifiers, a parallel connection of a plurality of amplifiers, and/or a combination thereof.

The radiating unit 30 may include at least one antenna for radiating an electromagnetic wave into a space. The at least one antenna may have a size and shape suitable for the size and shape of the aerosol-generating article. For example, if the aerosol-generating article is cylindrical, the at least one antenna may be tubular to surround the cylindrical aerosol-generating article. Here, the antenna being tubular may indicate that the antenna is tubular overall. In other words, if the antenna is formed of a metal (e.g., SUS) track, it may indicate the entire track is tubular overall. The shape of the at least one antenna is not limited to the examples described above, and may include various shapes such as a flat plate shape, a curved plate shape, and the like.

The radiating unit 30 may radiate an electromagnetic wave (e.g., the amplified RF signal or transmitted RF signal) into the insertion space to heat the aerosol-generating article. To maximize the heating efficiency of the aerosol-generating article, resonance of the electromagnetic wave needs to occur in the insertion space. The resonance condition (e.g., the resonance frequency) of the insertion space may vary depending on the amount of the dielectric included in the inserted aerosol-generating article. The processor 170 may adjust the control signal input to the RF signal generation circuit 210, thereby controlling the frequency of the RF signal generated by the RF signal generation circuit 210 to correspond to or approximate the resonance condition of the insertion space. The processor 170 may use the directional coupler 240 to obtain information about the resonance condition of the insertion space.

The directional coupler 240 may refer to a passive element having a waveguide structure capable of separating an incident wave and a reflected wave. The directional coupler 240 may separately receive the RF signal transmitted from the power amplifier 230 toward the radiating unit 30 and the electromagnetic wave radiated by the radiating unit 30 and then reflected from the insertion space. The directional coupler 240 may separate the transmitted RF signal and the reflected electromagnetic wave and transfer the transmitted RF signal and the reflected electromagnetic wave to the processor 170.

In an example, the aerosol-generating device 1 may further include an analog-to-digital converter (A/D converter) for converting the analog output of the directional coupler 240 to a digital output. The A/D converter may be embedded in the processor 170, or may be present as a separate component outside the processor 170. The processor 170 may monitor the output of the directional coupler 240 to analyze the characteristics (e.g., the current, voltage, power, phase, and/or frequency) of the transmitted RF signal and the characteristics (e.g., the current, voltage, power, phase, and/or frequency) of the reflected electromagnetic wave.

The processor 170 may verify whether the operation of the source unit 20 is being performed as intended, based on the characteristics of the transmitted RF signal. In addition, the characteristics of the transmitted RF signal may be used, together with the characteristics of the reflected electromagnetic wave, to determine the heating efficiency of the source unit 20 or the radiating unit 30. The processor 170 may control the source unit 20 such that the heating efficiency of the source unit 20 or the radiating unit 30 is maximized. For example, the processor 170 may adjust the frequency of the RF signal generated by the RF signal generation circuit 210 such that the power of the reflected electromagnetic wave may be minimized. The power of the reflected electromagnetic wave being minimized may indicate that the frequency of the RF signal approximates the resonance condition of the insertion space. The characteristics of the transmitted RF signal may provide a reference regarding whether the power of the reflected electromagnetic wave has been minimized.

Since resonance of the electromagnetic wave may occur in the insertion space according to the frequency of the RF signal, the insertion space may be referred to as a resonating unit. At least a portion of the insertion space may be surrounded by at least one shielding member to prevent the electromagnetic wave from leaking to the outside of the aerosol-generating device 1. According to one embodiment, the insertion space may further include a physical structure to cause the resonance condition to fall within a range controllable by the processor 170. The physical structure may include at least one conductor, and the resonance condition of the insertion space may vary depending on the arrangement, thickness, and length of the conductor. In addition, the physical structure may include a space for receiving a dielectric having a low electromagnetic wave absorbance, which is different from the dielectric included in the aerosol-generating article. The dielectric having a low electromagnetic wave absorbance may change the resonance frequency of the entire resonating unit without absorbing energy to be transmitted to an object to be heated. Accordingly, even when the resonating unit is miniaturized, the resonance condition may be determined within the range controllable by the processor 170.

The temperature sensing circuit 250 may be disposed in contact with or adjacent to the components included in the source unit 20 to measure the temperature of the source unit 20. For example, the temperature sensing circuit 250 may be disposed in contact with or adjacent to at least one of the RF signal generation circuit 210, the drive amplifier 220, and the power amplifier 230. During the process of generating and/or amplifying the RF signal, heat may be generated due to limited efficiency, and excessive heat generation may have negative effects on the components included in the source unit 20 or other components included in the aerosol-generating device 1. The temperature measured by the temperature sensing circuit 250 may be used to prevent the source unit 20 from overheating.

The processor 170 may receive the measured temperature (or a value corresponding to the temperature) from the temperature sensing circuit 250, and interrupt the operation of the source unit 20 upon determining that the source unit 20 is overheated. For example, the processor 170 may interrupt the supply of power to the source unit 20 or transmit a control signal, thereby interrupting the operation of the source unit 20. Hereinafter, the expression “supply of power to the source unit 20” is used to indicate control of whether the source unit 20 operates.

The temperature sensing circuit 250 may include at least one of a thermocouple, a resistance temperature detector (RTD), a thermistor, a semiconductor temperature sensor, and an optical temperature sensor. In an example, the temperature sensing circuit 250 may be implemented as a chip-type sensor (e.g., a negative temperature coefficient (NTC) sensor) to minimize the occupied area, but is not necessarily limited thereto.

Meanwhile, the aerosol-generating device 1 may further include components other than the components shown in FIG. 1. For example, the aerosol-generating device 1 may further a sensor unit, an output unit, an input unit, a communication unit, and a memory. In addition, if the aerosol-generating device 1 is a hybrid device that uses both an aerosol-generating article and a cartridge, the aerosol-generating device 1 may further include a cartridge heater. The cartridge heater may receive power from the power supply 130 and heat a medium in the cartridge and/or an aerosol-generating substance.

According to one embodiment, the sensor unit may detect the state of the aerosol-generating device 1 or the state of the surroundings of the aerosol-generating device 1, and may transmit the detected information to the processor 170. For example, the sensor unit may include a temperature sensor, a puff sensor, an insertion detection sensor, a reuse detection sensor, an overly moist state detection sensor, a cigarette identification sensor, a cartridge detection sensor, a cap detection sensor, and/or a movement detection sensor. Meanwhile, the sensor unit may further include various sensors, such as a liquid residual quantity sensor for detecting the residual quantity of liquid in the cartridge and an immersion sensor for detecting immersion of the aerosol-generating device 1.

According to one embodiment, the temperature sensor may detect the temperature of the insertion space or the aerosol-generating article. The temperature sensor may be in contact with or disposed adjacent to the insertion space or the aerosol-generating article and directly measure the temperature of the insertion space or the aerosol-generating article. Alternatively, the temperature sensor may be disposed apart from the insertion space or the aerosol-generating article and indirectly (e.g., contactlessly) measure the temperature of the insertion space or the aerosol-generating article. In an example, the temperature sensor may include an optical temperature sensor (e.g., an infrared temperature sensor).

According to one embodiment, the temperature sensor may detect the temperature of the power supply 130. The temperature sensor may be disposed adjacent to the power supply 130. For example, the temperature sensor may be attached to one surface of the power supply 130 (e.g., a battery) and/or may be mounted on one surface of a printed circuit board. In an example, the aerosol-generating device 1 may include a power supply protection circuit module (PCM), and the temperature sensor may be disposed adjacent to the power supply 130 together with the power supply protection circuit module. According to one embodiment, the temperature sensor may be disposed in a housing (not shown) of the aerosol-generating device 1 to detect the internal temperature of the housing (not shown).

According to one embodiment, the puff sensor may detect a user's puff.

In an example, the puff sensor may include a pressure sensor. The pressure sensor may output a signal corresponding to the internal pressure of the aerosol-generating device 1, and the processor 170 may determine the user's puff based on the signal corresponding to the internal pressure. Here, the internal pressure of the aerosol-generating device 1 may correspond to the pressure of an airflow path through which gas flows. The puff sensor may be disposed corresponding to the airflow path through which gas flows in the aerosol-generating device 1.

In another example, the puff sensor may include a temperature sensor. When the user's puff occurs, temperature drop may temporarily occur in the airflow path, the insertion space, and the aerosol-generating article. The processor 170 may determine the user's puff based on a signal corresponding to the temperature of the airflow path output from the temperature sensor.

In still another example, the puff sensor may include both a pressure sensor and a temperature sensor. In this case, the temperature sensor may measure temperature used to calibrate the internal pressure measured by the pressure sensor. In one example, the puff sensor may calibrate a signal corresponding to the internal pressure based on the temperature measured by the temperature sensor, and may output the calibrated signal. In another example, the puff sensor may output a signal corresponding to the temperature measured by the temperature sensor and a signal corresponding to the internal pressure measured by the puff sensor. In this case, the processor 170 may receive the signals, and may calibrate the signal corresponding to the internal pressure based on the signal corresponding to the temperature.

In still another example, the puff sensor may include a capacitance sensor. The capacitance sensor may also be called a cap sensor or a capacitive sensor. When the user's puff occurs, a temperature change and/or aerosol flow may occur in the insertion space, and accordingly, a dielectric constant in the insertion space may change. The processor 170 may determine the user's puff based on a signal corresponding to the dielectric constant in the insertion space output from the capacitance sensor.

The puff sensor is not limited to the examples described above, and may be implemented as various sensors for detecting the user's puff.

According to one embodiment, the insertion detection sensor may detect insertion and/or removal of the aerosol-generating article. The insertion detection sensor may be mounted adjacent to the insertion space.

In an example, the insertion detection sensor may include a capacitance sensor. The capacitance sensor may include at least one conductor, and the at least one conductor may be disposed adjacent to the insertion space. When the aerosol-generating article is inserted into or removed from the insertion space, capacitance around the conductor may change. The processor 170 may determine insertion and/or removal of the aerosol-generating article based on a signal corresponding to the dielectric constant in the insertion space output from the capacitance sensor.

In another example, the insertion detection sensor may include an inductive sensor. The inductive sensor may include at least one coil, and the at least one coil may be disposed adjacent to the insertion space. If the aerosol-generating article (e.g., a wrapper of the aerosol-generating article) includes a conductor, when the aerosol-generating article is inserted into or removed from the insertion space, a change in magnetic field may occur around the coil through which current flows. The processor 170 may determine insertion and/or removal of the aerosol-generating article including a conductor based on the characteristics of the current output from or detected by the inductive sensor (e.g., frequency of alternating current, a current value, a voltage value, an inductance value, and an impedance value). Alternatively, a susceptor SUS or the like may be included in the aerosol-generating article (e.g., a medium portion of the aerosol-generating article). In this case, a change in magnetic field may also occur around the coil based on insertion or removal of the susceptor or the like into or from the insertion space, and the processor 170 may determine insertion and/or removal of the aerosol-generating article based on the characteristics of the current of the inductive sensor.

The insertion detection sensor is not limited to the examples described above, and may be implemented as various sensors (e.g., a proximity sensor) for detecting insertion and/or removal of the aerosol-generating article. In addition, the insertion detection sensor may include any combination of the examples described above. According to one embodiment, the insertion detection sensor may include a switch or the like for detecting pressing by the aerosol-generating article.

According to one embodiment, the reuse detection sensor may detect whether the aerosol-generating article is being reused. In an example, the reuse detection sensor may be a color sensor for detecting the color of the aerosol-generating article. If the aerosol-generating article is used by the user, a change in the color of a portion of the wrapper may occur due to the generated aerosol or heating. The color sensor may output a signal corresponding to an optical characteristic (e.g., wavelength of light) corresponding to the color of the wrapper based on the light reflected from the wrapper. When a change in the color of a portion of the wrapper is detected, the processor 170 may determine that the aerosol-generating article inserted into the insertion space has already been used.

According to one embodiment, the overly moist state detection sensor may detect whether the aerosol-generating article is in an overly moist state. For example, the overly moist state detection sensor may include a capacitance sensor. The capacitance sensor may include at least one conductor disposed adjacent to the insertion space. The processor 170 may determine whether the aerosol-generating article is in an overly moist state based on the level of a signal corresponding to the dielectric constant or the like output from the capacitance sensor. In an example, the processor 170 may check a level range within which the level of the signal is included based on a look-up table, and may determine the moisture content of the aerosol-generating article based on the checked level range.

According to one embodiment, the cigarette identification sensor may detect whether the aerosol-generating article is authentic and/or may detect the type of the aerosol-generating article.

In an example, the cigarette identification sensor may include an optical sensor for detecting an identification material (or an identification mark) located on the outer surface (e.g., the wrapper) of the aerosol-generating article. The optical sensor may radiate light toward the identification material (or the identification mark) of the aerosol-generating article, and may detect whether the aerosol-generating article is authentic and/or may detect the type of the aerosol-generating article based on the reflected light. For example, the identification material may include a material (i.e., a luminous material) that emits light of a specific wavelength band based on the light radiated thereto. The processor 170 may determine whether the aerosol-generating article is authentic and/or may determine the type of the aerosol-generating article based on the range of the wavelength.

In another example, the cigarette identification sensor may include a capacitance sensor. The dielectric constant in the insertion space may vary depending on the type of the aerosol-generating article inserted into the insertion space. The processor 170 may determine whether the aerosol-generating article is authentic and/or may determine the type of the aerosol-generating article based on a signal corresponding to the dielectric constant or the like in the insertion space output from the capacitance sensor.

In still another example, the cigarette identification sensor may include an inductive sensor. If a conductor is included in the wrapper and/or inner portion (e.g., the medium portion) of the aerosol-generating article inserted into the insertion space, when the aerosol-generating article is inserted into the insertion space, the characteristics of the current detected by the inductive sensor (e.g., frequency of alternating current, a current value, a voltage value, an inductance value, and an impedance value) may vary depending on the type of the aerosol-generating article inserted into the insertion space. The processor 170 may determine whether the inserted aerosol-generating article is authentic and/or may determine the type of the inserted aerosol-generating article based on the characteristics of the current output from or detected by the inductive sensor.

The cigarette identification sensor is not limited to the examples described above, and may be implemented as various sensors for detecting whether the aerosol-generating article is authentic and/or detecting the type of the aerosol-generating article. In addition, the cigarette identification sensor may include any combination of the examples described above.

According to one embodiment, the cartridge detection sensor may detect mounting and/or removal of the cartridge. For example, the cartridge detection sensor may include an inductive sensor, a capacitance sensor, a resistance sensor, a Hall sensor (Hall IC), and/or an optical sensor.

According to one embodiment, the cap detection sensor may detect mounting and/or removal of the cap. For example, the cap detection sensor may include an inductive sensor, a capacitance sensor, a resistance sensor, a contact sensor, a Hall sensor (Hall IC), and/or an optical sensor. The cap may cover at least a portion of the cartridge mounted in or inserted into the aerosol-generating device 1 or may cover at least a portion of the housing of the aerosol-generating device 1. When the cap is mounted in or removed from the housing, the cap detection sensor may output a signal corresponding to mounting or removal, and the processor 170 may determine mounting or removal of the cap based on the signal corresponding to mounting or removal.

According to one embodiment, the movement detection sensor may detect movement of the aerosol-generating device 1. The movement detection sensor may be implemented as at least one of an acceleration sensor or a gyro sensor.

According to one embodiment, the sensor unit may further include at least one of a humidity sensor, an air pressure sensor, a magnetic sensor, a position sensor (global positioning system (GPS)), or a proximity sensor in addition to the sensors described above. The functions of the sensors can be intuitively deduced by those skilled in the art from the names thereof, and thus detailed descriptions thereof may be omitted.

According to one embodiment, the output unit may output information about the state of the aerosol-generating device 1 to provide the same to the user. The output unit may include, but is not limited to, a display, a haptic unit, and/or a sound output unit. For example, information about the aerosol-generating device 1 may include a charging/discharging state of the power supply 130 of the aerosol-generating device 1, an operational state of the source unit 20 or the radiating unit 30, an insertion/removal state of the aerosol-generating article and/or the cartridge, a mounting/removal state of the cap, or a state in which the use of the aerosol-generating device 1 is restricted (e.g., detection of an abnormal object). The display may visually provide the information about the state of the aerosol-generating device 1 to the user. For example, the display may include a light-emitting diode (LED), a liquid crystal display panel (LCD), and an organic light-emitting diode panel (OLED). If the display includes a touchpad, the display may also be used as an input unit. The haptic unit may haptically provide the information about the aerosol-generating device 1 to the user. For example, the haptic unit may include a vibration motor, a piezoelectric element, and an electrical stimulation device. The sound output unit may audibly provide the information about the aerosol-generating device 1 to the user. For example, the sound output unit may convert an electrical signal into an acoustic signal and may output the acoustic signal to the outside.

According to one embodiment, the input unit may receive information input from the user. For example, the input unit 15 may include a touch panel, a button, a keypad, a dome switch, a jog wheel, and a jog switch.

According to one embodiment, the memory may be hardware storing various pieces of data processed in the aerosol-generating device 1. The memory may store data processed and to be processed by the processor 170. For example, the memory may include at least one type of storage medium among a flash memory type memory, a hard disk type memory, a multimedia card micro type memory, a card type memory (e.g., SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. For example, the memory may store data on an operation time of the aerosol-generating device 1, the maximum number of puffs, the current number of puffs, at least one temperature profile, and the user's smoking pattern.

According to one embodiment, the communication unit may include at least one component for communication with other electronic devices (e.g., a portable electronic device). For example, the communication unit may include a Bluetooth communication unit, a Bluetooth low energy (BLE) communication unit, a near-field communication unit, a wireless local area network (WLAN) communication unit, a Zigbee communication unit, an infrared data association (IrDA) communication unit, a Wi-Fi direct (WFD) communication unit, an ultra-wideband (UWB) communication unit, an Ant+communication unit, a cellular network communication unit, an Internet communication unit, and a computer network (e.g., LAN or WAN) communication unit.

According to one embodiment, the processor 170 may control the amplification rate of the source unit 20 (e.g., the power amplifier 230) to control the temperature of the insertion space or the aerosol-generating article. The processor 170 may control the amplification rate of the source unit 20 (e.g., the power amplifier 230) based on the temperature of the insertion space or the aerosol-generating article, sensed using the temperature sensor. The processor 170 may control the amplification rate of the source unit 20 (e.g., the power amplifier 230) based on the temperature profile and/or the power profile stored in the memory.

In addition, the processor 170 may control the supply of power from the power supply 130 to the cartridge heater to control the temperature of the cartridge heater. The processor 170 may control the temperature of the cartridge heater and/or power supplied to the cartridge heater based on the temperature of the cartridge heater detected by the temperature sensor. The processor 170 may control the temperature of the cartridge heater and/or power supplied to the cartridge heater based on the temperature profile and/or the power profile stored in the memory.

According to one embodiment, the processor 170 may prevent the insertion space, the aerosol-generating article, and/or the cartridge heater from overheating. For example, the processor 170 may control, based on the temperature of the insertion space, the aerosol-generating article, and/or the cartridge heater exceeding a preset limit temperature, operation of the power conversion circuit such that the amount of power supplied to the source unit 20 or the cartridge heater is reduced or the supply of power to the source unit 20 or the cartridge heater is interrupted.

According to one embodiment, the processor 170 may control the supply of power to the source unit 20 or the cartridge heater based on a result of detection by the sensor unit.

According to one embodiment, the processor 170 may control the supply of power to the source unit 20 or the cartridge heater based on insertion and/or removal of the aerosol-generating article into and/or from the insertion space. For example, upon determining that the aerosol-generating article has been inserted into the insertion space using the insertion detection sensor, the processor 170 may perform control such that power is supplied to the source unit 20 or the cartridge heater. Upon determining that the aerosol-generating article has been removed from the insertion space using the insertion detection sensor, the processor 170 may interrupt the supply of power to the source unit 20 or the cartridge heater. The processor 170 may determine that the aerosol-generating article has been removed from the insertion space when the temperature of the insertion space or the aerosol-generating article is equal to or higher than a limit temperature or when the temperature change slope of the insertion space or the aerosol-generating article is equal to or greater than a preset slope.

According to one embodiment, the processor 170 may control, based on the state of the aerosol-generating article, a power supply time and/or the amount of power supplied to the source unit 20 or the cartridge heater. For example, upon determining that the aerosol-generating article is in an overly moist state using the overly moist state detection sensor, the processor 170 may increase a time during which power is supplied to the source unit 20 or the cartridge heater (e.g., a preheating time).

According to one embodiment, the processor 170 may control the supply of power to the source unit 20 or the cartridge heater based on whether the aerosol-generating article is being reused. For example, upon determining that the aerosol-generating article has already been used, the processor 170 may interrupt the supply of power to the source unit 20 or the cartridge heater.

According to one embodiment, the processor 170 may control the supply of power to the source unit 20 or the cartridge heater based on whether the cartridge has been coupled and/or removed. For example, upon determining that the cartridge has been removed using the cartridge detection sensor, the processor 170 may interrupt the supply of power to the source unit 20 or the cartridge heater or may perform control such that power is not supplied to the source unit 20 or the cartridge heater.

According to one embodiment, the processor 170 may control the supply of power to the source unit 20 or the cartridge heater based on whether the aerosol-generating substance in the cartridge has been exhausted. For example, upon determining that the temperature of the cartridge heater exceeds a limit temperature during preheating of the cartridge heater (i.e., in the preheating section), the processor 170 may determine that the aerosol-generating substance in the cartridge has been exhausted. Upon determining that the aerosol-generating substance in the cartridge has been exhausted, the processor 170 may interrupt the supply of power to the source unit 20 or the cartridge heater.

According to one embodiment, the processor 170 may control the supply of power to the source unit 20 or the cartridge heater based on whether use of the cartridge is possible. For example, upon determining, based on data stored in the memory, that the current number of puffs is equal to or greater than the maximum number of puffs set for the cartridge, the processor 170 may determine that use of the cartridge is impossible. Alternatively, when a total time period during which the cartridge heater is heated is equal to or longer than a preset maximum time period or when the total amount of power supplied to the cartridge heater is equal to or greater than a preset maximum amount of power, the processor 170 may determine that use of the cartridge is impossible. In this case, the processor 170 may interrupt the supply of power to the source unit 20 or the cartridge heater or may perform control such that power is not supplied to the source unit 20 or the cartridge heater.

According to one embodiment, the processor 170 may control the supply of power to the source unit 20 or the cartridge heater based on the user's puff. For example, the processor 170 may determine whether a puff occurs and/or the intensity of a puff using the puff sensor. When the number of puffs reaches a preset maximum number of puffs and/or when no puff is detected for a preset time period or longer, the processor 170 may interrupt the supply of power to the source unit 20 or the cartridge heater. When a puff is detected, the processor 170 may control the supply of power to the source unit 20 or the cartridge heater.

According to one embodiment, the processor 170 may control the supply of power to the source unit 20 or the cartridge heater based on whether the aerosol-generating article (or the cartridge) is authentic and/or the type of the aerosol-generating article (or the cartridge). For example, the processor 170 may determine whether the aerosol-generating article is authentic and/or may determine the type of the aerosol-generating article using the cigarette identification sensor. In an example, upon determining that the aerosol-generating article (or the cartridge) is inauthentic, the processor 170 may interrupt the supply of power to the source unit 20 or the cartridge heater. Upon determining that the aerosol-generating article (or the cartridge) is authentic, the processor 170 may control (e.g., commence) the supply of power to the source unit 20 or the cartridge heater. In another example, the processor 170 may control the supply of power to the source unit 20 or the cartridge heater differently depending on the type of the aerosol-generating article (or the cartridge). In more detail, upon determining that the aerosol-generating article (or the cartridge) is a first aerosol-generating article (or a first cartridge), the processor 170 may control the amplification rate of the source unit 20, or the temperature of the cartridge heater and/or power based on a first temperature profile (or a first power profile), and upon determining that the aerosol-generating article (or the cartridge) is a second aerosol-generating article (or a second cartridge), the processor 170 may control the amplification rate of the source unit 20, or the temperature of the cartridge heater and/or power based on a second temperature profile (or a second power profile).

According to one embodiment, the processor 170 may control the output unit based on a result of detection by the sensor unit. For example, when the number of puffs counted using the puff sensor reaches a preset number, the processor 170 may control the output unit to visually, haptically, and/or audibly provide information that operation of the aerosol-generating device 1 will end soon. For example, the processor 170 may control the output unit to visually, haptically, and/or audibly provide information about the temperature of the insertion space, the aerosol-generating article, or the cartridge heater.

According to one embodiment, based on occurrence of a predetermined event, the processor 170 may store a history of the corresponding event in the memory and may update the history. For example, the event may include events performed in the aerosol-generating device 1, such as detection of insertion of the aerosol-generating article, commencement of heating of the aerosol-generating article, detection of puff, termination of puff, detection of overheating, detection of application of overvoltage to the cartridge heater, termination of heating of the aerosol-generating article, on/off operation of the aerosol-generating device 1, commencement of charging of the power supply 130, detection of overcharging of the power supply 130, and termination of charging of the power supply 130. For example, the history of the event may include the occurrence date and time of the event and log data corresponding to the event. For example, when the predetermined event is detection of insertion of the aerosol-generating article, the log data corresponding to the event may include data on a value detected by the insertion detection sensor. For example, when the predetermined event is detection of overheating of the cartridge heater, the log data corresponding to the event may include data on the temperature of the cartridge heater, the voltage applied to the cartridge heater, and the current flowing through the cartridge heater.

According to one embodiment, the processor 170 may control the communication unit to form a communication link with an external device such as a user's mobile terminal.

According to one embodiment, upon receiving data on authentication from an external device via the communication link, the processor 170 may release restriction on use of at least one function (e.g., a heating function) of the aerosol-generating device 1. For example, the data on authentication may include the user's birthday, an identification number uniquely identifying the user, and whether authentication is completed by the user.

According to one embodiment, the processor 170 may transmit data on the state of the aerosol-generating device 1 (e.g., remaining capacity of the power supply 130 and operation mode) to the external device via the communication link. The transmitted data may be output through a display or the like of the external device.

According to one embodiment, upon receiving a request to search for the location of the aerosol-generating device 1 from the external device via the communication link, the processor 170 may control the output unit to perform an operation corresponding to location search. For example, the processor 170 may perform control such that the haptic unit generates vibration or the display outputs objects corresponding to location search and termination of search.

According to one embodiment, upon receiving firmware data from the external device via the communication link, the processor 170 may perform firmware update. According to one embodiment, the processor 170 may transmit data on a value detected by the at least one sensor unit to an external server (not shown) via the communication link, and may receive, from the server, and store a learning model generated by learning the detected value through machine learning such as deep learning. The processor 170 may perform the operation of determining the user's puff pattern and the operation of generating the temperature profile using the learning model received from the server.

Although not shown in FIG. 1, the aerosol-generating device 1 may further include a power supply protection circuit. The power supply protection circuit may include at least one switching element, and may block an electric path to the power supply 130 in response to overcharging and/or overdischarging of the power supply 130.

The aerosol-generating article mentioned in the present disclosure may include at least one aerosol-generating rod (e.g., a medium portion) and at least one filter rod. The radiating unit 30 may be disposed to correspond to the at least one aerosol-generating rod, and may be designed differently depending on the arrangement order and/or positions of the aerosol-generating rod and the filter rod. The aerosol-generating rod may contain at least one of nicotine, an aerosol-generating substance, and an additive. For example, the aerosol-generating substance may include glycerin (e.g., vegetable glycerin (VG)) and/or propylene glycol (PG) and may also include various other substances. For example, the additive may include a flavoring agent and/or an organic acid and may also include various other substances. For example, the aerosol-generating rod may include an aerosol-generating substrate (e.g., a sheet) impregnated with a liquid non-tobacco substance (e.g., an aerosol-generating substance and/or nicotine) and/or may contain a solid tobacco substance (e.g., leaf tobacco and reconstituted tobacco). The tobacco substance may be contained in the aerosol-generating rod in various forms, such as shredded tobacco, granules, and powder. According to one embodiment, the additive of the aerosol-generating rod may include an alkaline substance. Based on the alkaline substance, nicotine contained in the tobacco substance in the aerosol-generating rod may have an alkaline pH (e.g., pH 7.0 or higher). In this case, freebase nicotine may be released from the aerosol-generating rod even at a low temperature. According to one embodiment, the aerosol-generating rod may include two or more aerosol-generating rods, each of which may contain a tobacco substance and/or a non-tobacco substance. Meanwhile, although not shown, the at least one aerosol-generating rod and the at least one filter rod may individually and/or integrally be wrapped by at least one wrapper. In the present disclosure, the aerosol-generating article may be referred to as a stick.

The cartridge mentioned in the present disclosure may contain an aerosol-generating substance having any one state among a liquid state, a solid state, a gaseous state, and a gel state. The aerosol-generating substance may include a liquid composition. For example, the liquid composition may be a liquid containing a tobacco-containing substance including a volatile tobacco flavor component or may be a liquid containing a non-tobacco substance. Meanwhile, the cartridge may include a storage part that contains the aerosol-generating substance and/or a liquid delivery part that is impregnated with (contains) the aerosol-generating substance. For example, the liquid delivery part may include a wick formed of, e.g., cotton fiber, ceramic fiber, glass fiber, or porous ceramic. The cartridge heater may be included in the cartridge in a coil-shaped structure surrounding (or wound around) the liquid delivery part or a structure contacting one side of the liquid delivery part. Alternatively, the cartridge heater may be included in the aerosol-generating device 1, which is removable from the cartridge.

As used herein, the terms “substantially”, “approximately”, “generally”, and “about” in reference to a given parameter, property, or condition may include a degree that one of ordinary skill in the art would understand that the given parameter, property, or condition is met with a small degree of variance, such as within acceptable manufacturing tolerances. For example, a parameter that is substantially met may be at least 90% met, at least 95% met, or at least 99% met.

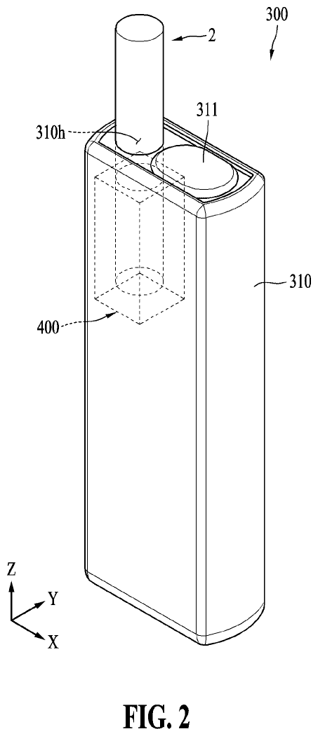

FIG. 2 is a perspective view of an aerosol-generating device.

Referring to FIG. 2, an aerosol-generating device 300 may be configured to generate an aerosol from an aerosol-generating article 2. The aerosol-generating device 300 may include a housing 310 for accommodating the aerosol-generating article 2 and a heater assembly 400 for heating the aerosol-generating article 2 accommodated in the housing 310.

The housing 310 may form the overall exterior of the aerosol-generating device 300, and components of the aerosol-generating device 300 may be disposed in an internal space (or a “mounting space”) of the housing 310. For example, the heater assembly 400, a battery, a processor, and/or a sensor may be disposed in the internal space of the housing 310, but the components disposed in the internal space are not limited thereto.

A housing opening 310h may be formed in an area of the housing 310. At least one area of the aerosol-generating article 2 may be inserted into the housing 310 through the housing opening 310h. For example, the housing opening 310h may be formed in an area of the upper surface (e.g., the surface in the +Z normal direction) of the housing 310.

The heater assembly 400 may be disposed in the internal space of the housing 310 and may heat the aerosol-generating article 2 inserted into or accommodated in the housing 310 through the housing opening 310h. For example, the heater assembly 400 may be disposed to enclose at least one area of the aerosol-generating article 2 inserted into or accommodated in the housing 310 to heat the aerosol-generating article 2.

The heater assembly 400 may heat the aerosol-generating article 2 by dielectric heating. Herein, “dielectric heating” may refer to heating a dielectric, which is a target to be heated, using resonance of microwaves and/or an electric field of microwaves (or including a magnetic field). Microwaves are an energy source to heat the target to be heated. Since microwaves are generated by high-frequency power, hereinafter, microwaves may be used interchangeably with microwave power.

A charge or ion of a dielectric included in the aerosol-generating article 2 may vibrate or rotate by microwave resonance in the heater assembly 400, and the aerosol-generating article 2 may be heated as heat is generated from the dielectric by frictional heat, which is generated while the charge or ion vibrates or rotates.

As the aerosol-generating article 2 is heated by the heater assembly 400, an aerosol may be generated from the aerosol-generating article 2. Herein, the “aerosol” may refer to gas particles generated by mixing air and vapor that is generated as the aerosol-generating article 2 is heated.

The aerosol generated from the aerosol-generating article 2 may pass through the aerosol-generating article 2 or may be discharged to the outside of the aerosol-generating device 300 via an empty space between the aerosol-generating article 2 and the housing opening 310h. The user may smoke by contacting their mouth with an area of the aerosol-generating article 2 exposed to the outside of the housing 310 and inhaling the aerosol discharged to the outside of the aerosol-generating device 300.

The aerosol-generating device 300 may include a cover 311 movably disposed in the housing 310 to open or close the housing opening 310h. The cover 311 may be slidably coupled to the upper surface (e.g., the surface in the +Z normal direction) of the housing 310 and may expose the housing opening 310h to the outside of the aerosol-generating device 300 or prevent the housing opening 310h from being exposed to the outside of the aerosol-generating device 300 by covering the housing opening 310h.

The cover 311 may expose the housing opening 310h to the outside of the aerosol-generating device 300, at a first position (e.g., an open position). When the aerosol-generating device 300 is exposed to the outside, the aerosol-generating article 2 may be inserted into the housing 310 through the housing opening 310h.

The cover 311 may prevent the housing opening 310h from being exposed to the outside of the aerosol-generating device 300 by covering the housing opening 310h, at a second position (e.g., a closed position). In this case, when the aerosol-generating device 300 is not in use, the cover 311 may prevent an external foreign substance from entering the heater assembly 400 through the housing opening 310h.

Although FIG. 1 only illustrates the aerosol-generating device 300 to heat the aerosol-generating article 2 in a solid state, the aerosol-generating device 300 is not limited to the illustrated embodiments. Through the heater assembly 400, the aerosol-generating device 300 may generate an aerosol by heating an aerosol-generating article in a liquid or gel state rather than the aerosol-generating article 2 in the solid state. The aerosol-generating device 300 may include a cartridge (or “vaporizer”) for heating an aerosol-generating article, wherein the cartridge includes an aerosol-generating article in a liquid or gel state and the heater assembly 400 for heating the aerosol-generating article 2. The aerosol generated from the aerosol-generating article may travel to the aerosol-generating article 2 along an airflow path that communicates the cartridge with the aerosol-generating article 2, may be mixed with the aerosol generated from the aerosol-generating article 2, may pass through the aerosol-generating article 2, and may be transferred to the user.

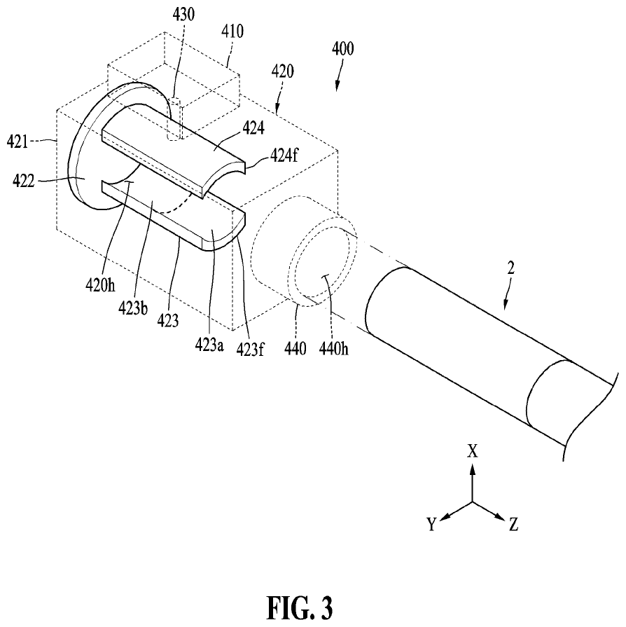

FIG. 3 is a perspective view of a heater assembly.

Referring to FIG. 3, the heater assembly 400 may include a generator 410 (e.g., the source unit 20 of FIG. 1) configured to generate electromagnetic waves. The electromagnetic waves generated by the generator 410 may be transmitted to a space in which the aerosol-generating article 2 is accommodated. For example, the generator 410 may output microwave power to a resonator 420.

The electromagnetic waves may be microwaves. For example, the microwave may have a wavelength between 1 millimeter (mm) and 1 meter (m). The heater assembly 400 may include the resonator 420 in which the electromagnetic waves radiated by the generator 410 are resonated. The resonator 420 may include a cavity 420h configured to accommodate the aerosol-generating article 2. The electromagnetic waves resonated by the resonator 420 may be transmitted to the cavity 420h, and the aerosol-generating article 2 may be heated by the transmitted electromagnetic waves. The heater assembly 400 may include a coupler 430 that provides electromagnetic waves to the resonator 420. The coupler 430 may provide the electromagnetic waves generated by the generator 410 to the resonator 420.

The resonator 420 may include a case 421, a first plate 423 including a conductor, a second plate 424 including a conductor and substantially opposite to the first plate 423, and a connecting portion 422 for connecting the case 421 to the first plate 423 and the second plate 424. The shape of the second plate 424 may be substantially the same as the shape of the first plate 423. The coupler 430 may provide electromagnetic waves to at least one of the first plate 423 and the second plate 424 to cause electromagnetic wave resonance in the resonator 420.

The resonator 420 may surround at least one area of the inserted aerosol-generating article 2. When electromagnetic waves are provided to the resonator 420, electromagnetic wave resonance may occur in the resonator 420, and accordingly, the resonator 420 may heat the aerosol-generating article 2. For example, dielectrics included in the aerosol-generating article 2 may generate heat by an electromagnetic field generated inside the resonator 420 by the electromagnetic waves, and the aerosol-generating article 2 may be heated by the heat generated by the dielectrics.

The case 421 may include a conductor. The case 421 may function as an outer conductor. Components of the resonator 420 may be disposed inside the case 421. The case 421 may include the cavity 420h in which the aerosol-generating article 2 is accommodated and a heater opening 440h in which the aerosol-generating article 2 is inserted. The case 421 may include a sleeve 440 that defines the heater opening 440h. The sleeve 440 may be configured to seal electromagnetic waves. The heater opening 440h may be connected to the cavity 420h. The heater opening 440h may open toward the outside of the case 421, and the cavity 420h may be connected to the outside via the heater opening 440h. The aerosol-generating article 2 may be inserted into the cavity 420h of the case 421 via the heater opening 440h of the case 421.

Although it is illustrated that the case 421 has a square cross-sectional shape, the shape of the case 421 may be deformed into various shapes. For example, the structure of the case 421 may be deformed to have various cross-sectional shapes, including a rectangle, an oval, or a circle. The case 421 may longitudinally extend in one direction (e.g., the Z-axis direction).

The first plate 423 and the second plate 424 that may function as internal conductors of the resonator 420 may be disposed in the case 421. The first plate 423 and the second plate 424 may define the cavity 420h therebetween. The first plate 423 and the second plate 424 may be spaced apart from each other in the circumferential direction of the aerosol-generating article 2 accommodated in the cavity 420h. The plate 423 may be disposed to surround an area of the aerosol-generating article 2, and the second plate 424 may be disposed to surround another area of the aerosol-generating article 2.

The first plate 423 and the second plate 424 may be connected to the case 421 by the connecting portion 422. An end (e.g., an end portion in the-Z direction) of the first plate 423 may be connected to an end (e.g., an end portion in the-Z direction) of the second plate 424 by the connecting portion 422. At the end of the first plate 423 and the end of the second plate 424, a closed end portion may be formed by the connecting portion 422.

The other end (e.g., an end portion in the +Z direction) of the first plate 423 and the other (e.g., an end portion in the +Z direction) of the second plate 424 may be open by being spaced apart from each other. Since the other end 423f of the first plate 423 and the other end 424f of the second plate 424 are spaced apart from each other, the first plate 423 and the second plate 424 may form an open end portion at the other ends.

As the first plate 423 and the second plate 424 are connected to the connecting portion 422, a resonator assembly may be completed. The shape of a cross-section cut in the longitudinal direction of the resonator assembly may include a horseshoe shape.

The first plate 423 and the second plate 424 may extend in the longitudinal direction (e.g., the Z-axis direction) of the aerosol-generating article 2. At least a portion of the first plate 423 and at least a portion of the second plate 424 may be bent to protrude outwardly from the center of the longitudinal direction of the aerosol-generating article 2. For example, when the aerosol-generating article 2 has a cylindrical shape, the first plate 423 and the second plate 424 may be bent in a circumferential direction along the outer circumferential surface of the aerosol-generating article 2. According to the structure in which the first plate 423 and the second plate 424 are bent in the circumferential direction along the outer circumferential surface of the aerosol-generating article 2, since a more uniform magnetic field is formed in the resonator 42, the heater assembly 400 may uniformly heat the aerosol-generating article 2.

The radiuses of curvatures of the cross-sections of the first plate 423 and the second plate 424 may be substantially the same as the radius of curvature of the cross-section of the aerosol-generating article 2. The radiuses of curvatures of the cross-sections of the first plate 423 and the second plate 424 may be greater or less than the radius of curvature of the cross-section of the aerosol-generating article 2.

An open end portion of the other end 423f of the first plate 423 and an open end portion of the other end 424f of the second plate 424 may be positioned to face the heater opening 440h of the case 421. The heater opening 440h of the case 421 may be spaced apart in a direction away from the end portions of the other end 423f of the first plate 423 and the other end 424f of the second plate 424.

The open end portions of the other end 423f of the first plate 423 and the other end 424f of the second plate 424 may be aligned with the heater opening 440h of the case 421. Accordingly, when the aerosol-generating article 2 is inserted into and positioned in the cavity 420h via the heater opening 440h of the case 421, a portion of the aerosol-generating article 2 in the cavity 420h may be surrounded by the first plate 423 and the second plate 424. The numbers of first plates 423 and second plates 424 are not limited to the embodiments, and the numbers of first plates 423 and/or second plates 424 may be, for example, two, three or more.

The first plate 423 and the second plate 424 may be symmetrically disposed based on the center axis in the longitudinal direction of the aerosol-generating article 2, in other words, in a direction in which the aerosol-generating article 2 extends.

Since a strong electromagnetic field is formed around the open end portion (e.g., the other end 423f of the first plate 423 and the other end 424f of the second plate 424), the aerosol-generating article 2 may be easily heated. For example, the strongest electromagnetic field may be generated at the open end portion in which a resonance peak is formed on the side surface of the resonator 420. The structure of the resonator 420 may prevent the electromagnetic field from leaking in the direction of the heater opening 440h rather than an area of the resonator 420. In other words, the electromagnetic field leaked to the aerosol-generating article 2 from the open end portion may only heat the aerosol-generating article 2 and may not propagate to the outside (e.g., toward the mouth of the user). Since the electromagnetic field does not propagate (or leak) to a space other than the area of the resonator 420, a separate structure (e.g., the sleeve 440) for shielding the electromagnetic field may not be required.

For example, the diameter of the heater opening 440h may be less than half of the wavelength of an electromagnetic wave. When the diameter of the heater opening 440h is less than half of the wavelength of the electromagnetic wave, the electromagnetic wave that causes resonance may be cut off. A cavity of the resonator 420 may be filled with a low-loss dielectric (Teflon, quartz, alumina, etc.). When the cavity is filled with the low-loss dielectric, the size of the resonator 420 may be further reduced.

The aerosol-generating device 300 for resonating electromagnetic waves using the resonator 420 formed based on the heater assembly 400 is described with reference to FIG. 3, but the method of resonating electromagnetic waves is not limited thereto.

When the aerosol-generating article 2 is accommodated in cavity 420h, the inner surface of the first plate 423 in contact with the aerosol-generating article 2 may include a first area 423a (e.g., an area adjacent in the +Z direction) adjacent to the heater opening 440h and a second area 423b (e.g., an area adjacent in the-Z direction) that is different from the first area 423a. Although the present disclosure describes that an embossed surface 423s is formed on the inner surface of the first plate 423 based on the first plate 423, since the second plate 424 may be formed substantially the same as the first plate 423, it is obvious that an embossed surface may be formed on the second plate 424 in a similar manner to the first plate 423.

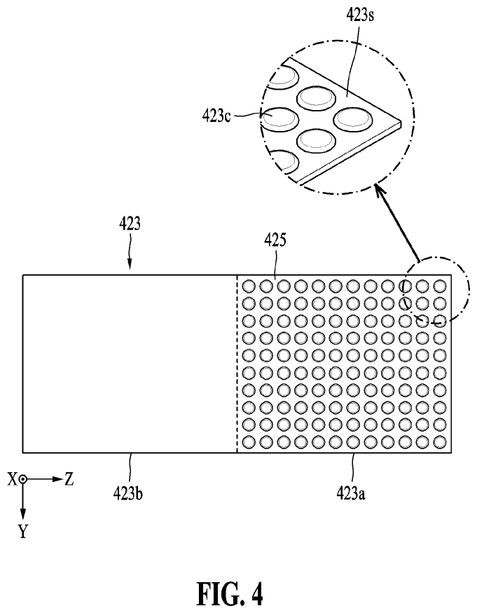

FIG. 4 is a plan view of an embossed surface.

Referring to FIG. 4, the inner surface of the first plate 423 may include the first area 423a, which includes the embossed surface 423s, and the second area 423b. The embossed surface 423s may scatter electromagnetic waves. The embossed surface 423s formed in the first area 423a may scatter a strong electromagnetic field formed around an open end portion (e.g., the other end 423f (e.g., the end portion in the +Z direction) of the first plate 423 or the other end 424f (e.g., the end portion in the +Z direction) of the second plate 424). This may cause the aerosol-generating article 2 to be uniformly heated.

The second area 423b adjacent to a closed end portion (e.g., the one end (e.g., the end portion in the-Z direction) of the first plate 423 or the one end (e.g., the end portion in the-Z direction) of the second plate 424) in which a relatively weak electromagnetic field is formed may not include an embossed surface. Although the embodiment of FIG. 4 illustrates that the second area 423b does not include an embossed surface, it is obvious that the second area 423b may include an embossed surface, substantially the same as the first area 423a.

The embossed surface 423s may include circular embossed structures 423c protruding from the surface of the first plate 423. Although it is described that the embossed structures 423c protrude, the example is not limited thereto. The embossed structures 423c may include a concave structure from the surface of the first plate 423 to scatter electromagnetic waves. The plurality of circular embossed structures 423c may form an embossed pattern. In other words, the embossed surface 423s may include a circular pattern. Herein, a high density of the embossed pattern may be defined as a narrow gap between the embossed structures 423c or a large number of the embossed structures 423c per unit area. Conversely, herein, a low density of the embossed pattern may be defined as a wide gap between the embossed structures 423c or a small number of the embossed structures 423c per unit area.

The first plate 423 may include a coating 425 disposed on the embossed surface 423s and configured to scatter electromagnetic waves. Although the present disclosure describes that the coating 425 is disposed on the embossed surface 423s, the example is not limited thereto. In one embodiment, the coating 425 may be disposed on the inner surface of the first plate 423 on which the embossed surface 423s is not disposed, and the coating 425 may solely cause scattering of electromagnetic waves.

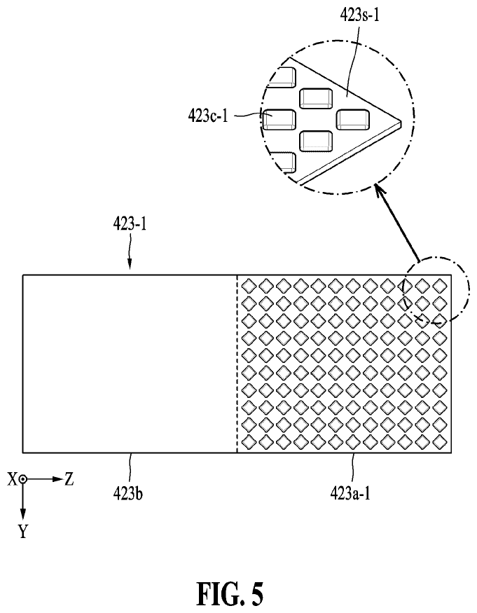

FIG. 5 is a plan view of an embossed surface.

Referring to FIG. 5, the inner surface of a first plate 423-1 may include a first area 423a-1, including an embossed surface 423s-1, and a second area 423b. The embossed surface 423s-1 may include polygonal (e.g., rectangular) embossed structures 423c-1 protruding from the surface of the first plate 423.

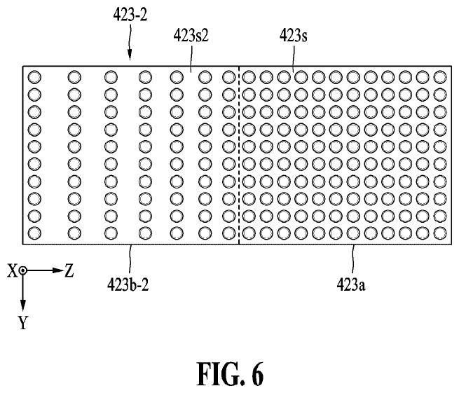

FIG. 6 is a plan view of an embossed surface.

Referring to FIG. 6, the inner surface of a first plate 423-2 may include the first area 423a including the embossed surface 423s, and a second area 423b-2 including a second embossed surface 423s2. The second embossed surface 423s2 may include a circular embossed structure (e.g., the embossed structures 423c of FIG. 4) protruding from the surface of the first plate 423-2. The density of an embossed pattern in the second area 423b-2 may be less than the density of an embossed pattern in the first area 423a. Although it is described that the density of the embossed pattern in the first area 423a is uniform, the example is not limited thereto, and the embossed structures may be disposed so that the density gradually increases from an end (e.g., the end portion in the-Z direction) of the first plate 423 to the other end (e.g., the end portion in the +Z direction).

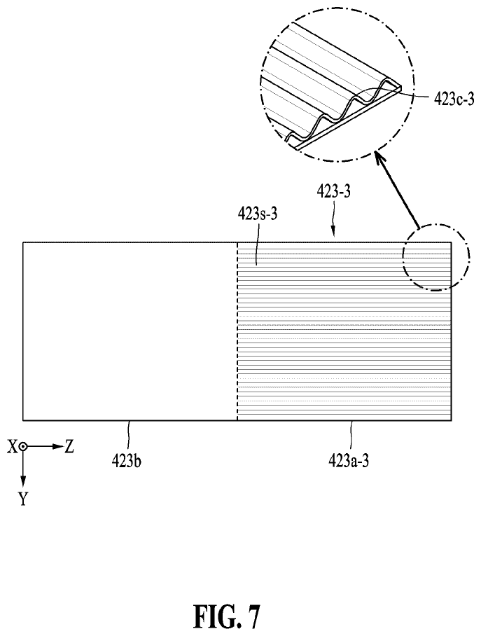

FIG. 7 is a plan view of an embossed surface.

Referring to FIG. 7, the inner surface of a first plate 423-3 may include a first area 423a-3, which includes an embossed surface 423s-3, and the second area 423b. The embossed surface 423s-3 may include a ribbed pattern. The embossed surface 423s-3 may include an embossed structure 423c-3 forming a winding shape (in other words, the ribbed pattern) on the surface of the first plate 423-3. The embossed structure 423c-3 may form peaks and valleys. A small distance between peaks or a narrow gap between valleys may be defined as a high density of the embossed pattern, and a large distance between peaks or a wide gap between valleys may be defined as a low density of the embossed pattern. Although the embodiment of FIG. 7 illustrates that an embossed pattern is not formed in the second area 423b, an embossed pattern with a lower density than the embossed pattern in the first area 423a-3 may be formed in the second area 423b.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An aerosol-generating device comprising:
a generator configured to generate a microwave;
a resonator configured to resonate the microwave and comprising a conductor that defines a cavity configured to accommodate an aerosol-generating article; and
an opening in which the aerosol-generating article is inserted,
wherein the conductor includes a first area that is adjacent to the opening and includes an embossed surface, and a second area that is different from the first area.

2. The aerosol-generating device of claim 1, wherein the embossed surface includes a circular pattern.

3. The aerosol-generating device of claim 1, wherein the embossed surface includes a polygonal pattern.

4. The aerosol-generating device of claim 1, wherein the embossed surface includes a ribbed pattern.

5. The aerosol-generating device of claim 1, wherein the conductor further comprises a coating disposed on the embossed surface and configured to scatter a microwave.

6. The aerosol-generating device of claim 1, wherein the second area includes an embossed surface.

7. The aerosol-generating device of claim 6, wherein a density of a pattern of the embossed surface of the first area is higher than a density of a pattern of the embossed surface of the second area.

8. The aerosol-generating device of claim 6, wherein the embossed surface of the second area includes a circular pattern.

9. An aerosol-generating device comprising:
a generator configured to generate a microwave;
a resonator configured to resonate the microwave and comprising a conductor that defines a cavity configured to accommodate an aerosol-generating article; and
an opening in which the aerosol-generating article is inserted,
wherein the conductor comprises:
a first plate surrounding an area of the aerosol-generating article and including
a first area adjacent to the opening and including an embossed surface and a second area that is different from the first area, and
a second plate surrounding another area of the aerosol-generating article and spaced apart from the first plate in a circumferential direction of the aerosol-generating article.

10. The aerosol-generating device of claim 9, wherein the embossed surface includes a circular pattern.

11. The aerosol-generating device of claim 9, wherein the embossed surface includes a polygonal pattern.

12. The aerosol-generating device of claim 9, wherein the embossed surface includes a ribbed pattern.

13. The aerosol-generating device of claim 9, wherein the second area includes an embossed surface.

14. The aerosol-generating device of claim 13, wherein a density of a pattern of the embossed surface of the first area is higher than a density of a pattern of the embossed surface of the second area.

15. The aerosol-generating device of claim 13, wherein the embossed surface of the second area includes a circular pattern.
